(19) United States
(12) Patent Application Publication
(10) Pub. No.: US 2009/0073175 A1
(43) Pub. Date: Mar. 19, 2009

(54) DISPLAY PROCESSING APPARATUS, DISPLAY PROCESSING METHOD AND DISPLAY PROCESSING PROGRAM

(75) Inventors: Reiji Matsumoto, Saitama (JP); Hajime Adachi, Saitama (JP); Kazuo Murata, Saitama (JP); Yuya Kawagishi, Saitama (JP)

Correspondence Address: YOUNG & THOMPSON, 209 Madison Street, Suite 500, ALEXANDRIA, VA, 22314, US

(73) Assignee: PIONEER CORPORATION, Tokyo (JP)

(21) Appl. No.: 12/295,539

(22) PCT Filed: Mar. 23, 2007
(86) PCT No.: PCT/JP2007/056084

§ 371 Date: Nov. 13, 2008

(30) Foreign Application Priority Data
Mar. 13, 2006 (JP) 2006-099053

(51) Int. Cl. G06T 11/00

(52) U.S. Cl. 345/467

(57) ABSTRACT

By storing pre-rasterized bitmap data and scalable font data in separate storage unit, even when a hard disk drive is disabled, it is possible to assure a function of displaying a required minimum number of (or a certain number of) a character or visual object by the scalable font data in a flash memory.

### CROSS-REFERENCE TO RELATED APPLICATION

This application is based on Japanese Patent Application No. 2006-099053 filed on Mar. 31, 2006, the contents of which is incorporated hereinto by reference.

### BACKGROUND OF THE INVENTION

1. Field of the Invention

The present invention relates to a display processing apparatus, a display processing method, and a display processing program for navigation systems and the like.

2. Description of the Related Art

In a navigation system, for example, characters for place names and so on contained in maps, character strings for options in menus and so on, and character strings as other descriptions are rendered on a screen using font data provided in the system. In particular, the recent navigation systems intend to use a high-definition display apparatus, and are required to provide an improved character expressing capability and availability of characters in various sizes. In response to such requirements, those systems use scalable fonts. The scalable fonts express vectorially a locus of a character and allow display of characters in any size. On a side note, in rendering with the scalable fonts, it is necessary to first create data in the bitmap format through an expansion process. This causes a problem in that rendering takes more time due to a heavy workload for the process, as compared to a case of displaying various character strings with a bitmap font composed of data in the bitmap format.

Therefore, there is a conventionally known device to deal with such a problem. For example, JP, A, 2005-9936 discloses a navigation system in which a storage means (font memory) stores the above described scalable font data and pre-rasterized bitmap data (bitmap font data) of scalable fonts for frequently-used characters expanded in advance in desired sizes, and the pre-rasterized bitmap data is read if the pre-rasterized bitmap data corresponding to a designated character code is stored in the storage means and the scalable font data corresponding to the character code is read and expanded into bitmap data if no pre-rasterized bitmap data is stored in the storage means (refer to JP, A, 2005-9936, for example).

In the above described related art, by reading and displaying the pre-rasterized bitmap data of frequently-used characters stored in advance in the storage means, it is possible to reduce occasions when the scalable font data requiring long processing time is used, thereby shortening a time required for display of characters.

However, since both the scalable font data and the pre-rasterized bitmap data are stored in a single storage means, if the storage means becomes temporarily disabled for some reason such as rewriting of data stored in the storage means or replacement of the storage means itself, for example, neither the scalable font data nor the pre-rasterized bitmap data can be read, thereby totally disabling display of characters on a display device.

The above described problem is given as one of examples the present invention should solve.

### SUMMARY OF THE INVENTION

To solve the above described problem, the invention according to claim 1 is a display processing apparatus generates and outputs display data for displaying a character or visual object (such as a symbol mark, a code, or the like) on a display means, including: a temporary storage means that stores and holds the display data in a readable and writable manner; a pre-rasterized data read processing means that reads pre-rasterized bitmap data related to a character or visual object, which is stored and held in a first storage means, and storing the pre-rasterized bitmap data in the temporary storage means; and a scalable data read processing means that reads scalable font data related to a character or visual object, which is stored and held in a second storage means provided separately from the first storage means, and stores said scalable font data in the temporary storage means.

To solve the above described problem, the invention according to claim 6 is a display processing method for generating and outputting display data for displaying a character or visual object on a display means, including: a first step for reading pre-rasterized bitmap data related to a character or visual object, which is stored and held in a first storage means, and storing the pre-rasterized bitmap data in a temporary storage means in a readable and writable manner; and a second step for reading scalable font data related to a character or visual object, which is stored and held in a second storage means separate from the first storage means, and storing said scalable font data in the temporary storage means.

To solve the above described problems, the invention according to claim 8 allows a computation means provided in a display processing apparatus to execute: a first step for reading pre-rasterized bitmap data related to a character or visual object, which is stored and held in a first storage means, and storing the pre-rasterized bitmap data in a temporary storage means in a readable and writable manner; and a second step for reading scalable font data related to a character or visual object, which is stored and held in a second storage means separate from the first storage means, and storing said scalable font data in the temporary storage means.

### BRIEF DESCRIPTION OF THE DRAWINGS

FIG. 1 is a block diagram showing an overall functional configuration of a vehicle navigation system having a display processing apparatus in an embodiment of the present invention;

FIG. 2 is a functional block diagram showing main parts which are extracted from the functional configuration of the display processing apparatus in an embodiment of the present invention;

FIG. 3 is a flowchart showing a control process executed by a storage control part;

FIG. 4 is a flowchart showing a control process executed by a rendering control part; and

FIG. 5 is a flowchart showing a control process executed by a storage control part in a modified embodiment in which all pre-rasterized bitmap data in an HDD is read and recorded, and thereafter collectively made resident.

### DETAILED DESCRIPTION OF THE PREFERRED EMBODIMENTS

The following describes an embodiment of the present invention with reference to accompanying drawings.

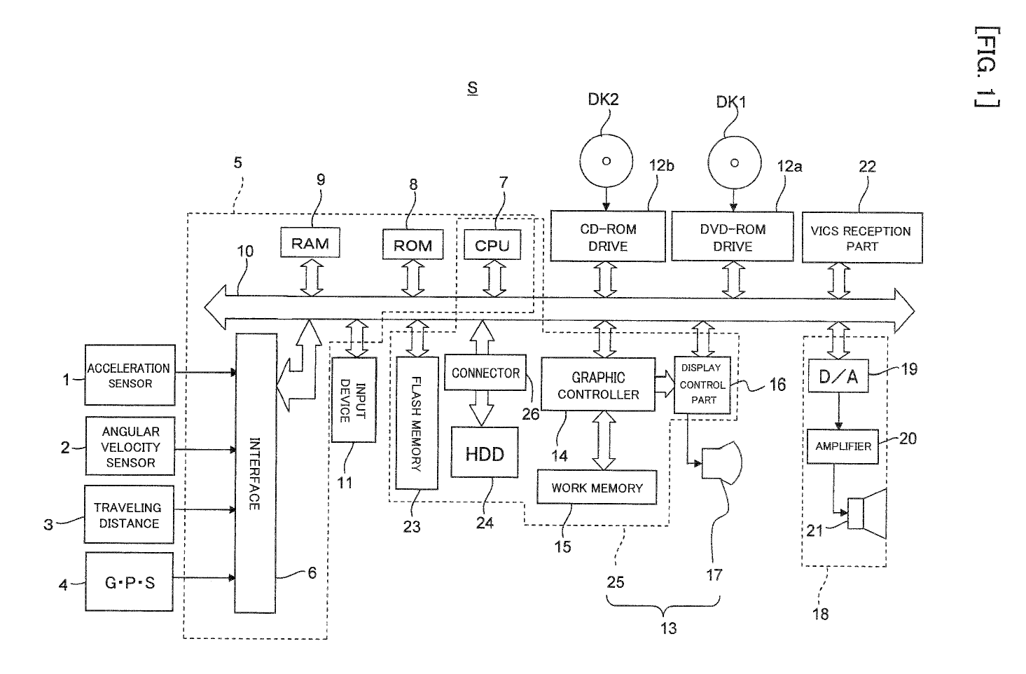

FIG. 1 is a block diagram showing an overall functional configuration of a vehicle navigation system having a display processing apparatus in the present embodiment.

As shown in FIG. 1, a vehicle navigation system S includes: an acceleration sensor 1 for detecting an acceleration in a direction of travel which is actually applied to a vehicle when the vehicle is started, stopped, accelerated, or decelerated, and outputting acceleration data; an angular velocity sensor 2 for detecting an angular velocity of the vehicle at the time of rotation and outputting angular velocity data and relative bearing data; a traveling distance sensor 3 for detecting a vehicle speed pulse signal corresponding to rotation of a wheel; and a global positioning system (GPS) receiver 4 for receiving a radio wave from a GPS satellite and outputting GPS positioning data such as latitude and longitude at which the vehicle is located, and outputting absolute bearing data in the direction of travel of the vehicle. In this arrangement, the acceleration sensor 1 may of various types such as semiconductor acceleration sensors of capacitance type, piezo type and the like, and acceleration sensors of piezoelectric element type, for example.

Further, the navigation system S includes: a system controller 5 for controlling the overall navigation system on the basis of the acceleration data, relative bearing data, angular velocity data, traveling distance data, GPS positioning data and absolute bearing data, which are output from the acceleration sensor 1, the angular velocity sensor 2, the traveling distance sensor 3 and the GPS receiver 4, respectively; an input device 11 such as a key operation panel or a remote control for inputting various kinds of data; a hard disk drive 24, a flash memory 23, a DVD read only memory (DVD-ROM) drive 12a, and a compact disk read only memory (CD-ROM) drive 12b for reading various kinds of data such as map data including road data indicative of the number of lanes, the widths of roads and the like, and detailed information on roadside facilities, from at least one of the hard disk drive 24, the flash memory 23, the DVD-ROM disk DK1 and the CD-ROM disk DK2, and outputting the same, under control of the system controller 5; a display unit 13 for displaying various kinds of display data under control of the system controller 5; a sound reproduction unit 18 for reproducing and outputting various kinds of audio data under control of the system controller 5; and a VICS receiving part 22 for receiving traffic congestion information based on a VICS (Vehicle Information and Communication System).

In addition, the system controller 5 includes: an interface part 6 for interfacing with an external sensor such as the GPS receiver 4; a CPU 7 for calculating a traveling distance of the vehicle by measuring the number of pulses in the vehicle speed pulse signal from the traveling distance sensor 3, and controlling the overall system controller 5; a ROM (Read Only Memory) 8 for storing a control program and the like for controlling the system controller 5 and the like; and a RAM (Random Access Memory) 9 for storing various kinds of readable and writable data such as route data preset by a user via the input device 11, and the system controller 5 is connected via a bus line 10 to the input device 11, the hard disk drive 24, the flash memory 23, the DVD-ROM drive 12a, the CD-ROM drive 12b, the display unit 13, the sound reproduction unit 18 and the VICS receiver 22.

The display unit 13 has a display 17 such as an LCD device or a CRT display device, and a display processing apparatus 25 for generating and outputting display data for displaying a character or visual object on the display 17. The display processing apparatus 25 is formed of: the CPU 7; a graphic controller 14 for controlling the overall display unit 13 on the basis of control data transmitted from the CPU 7 via the bus line 10; and a memory such as VRAM (Video RAM), and is constituted by: a work memory 15 for storing and holding temporarily image information of a character, a visual object or the like, in a readable and writable manner; a display control part 16 for controlling display on the display 17 on the basis of the image data output from the graphic controller 14; the flash memory 23 for storing scalable font data related to a character or visual object; and the hard disk drive 24 having a hard disk (not shown) for storing pre-rasterized bitmap font data related to a character or visual object, and the like. Incidentally, the hard disk drive 24 is installed by a connector 26 in an attachable and detachable manner.

The sound reproduction unit 18 includes: a D/A converter 19 for carrying out a D/A conversion of audio digital data transmitted via the bus line 10 from at least one of the hard disk drive 24, the flash memory 23, the DVD-ROM drive 12a, the CD-ROM drive 12b and the RAM 9; an amplifier 20 for amplifying an audio analog signal output from the D/A converter 19; and a speaker 21 for converting the amplified audio analog signal into sound and outputting the same externally.

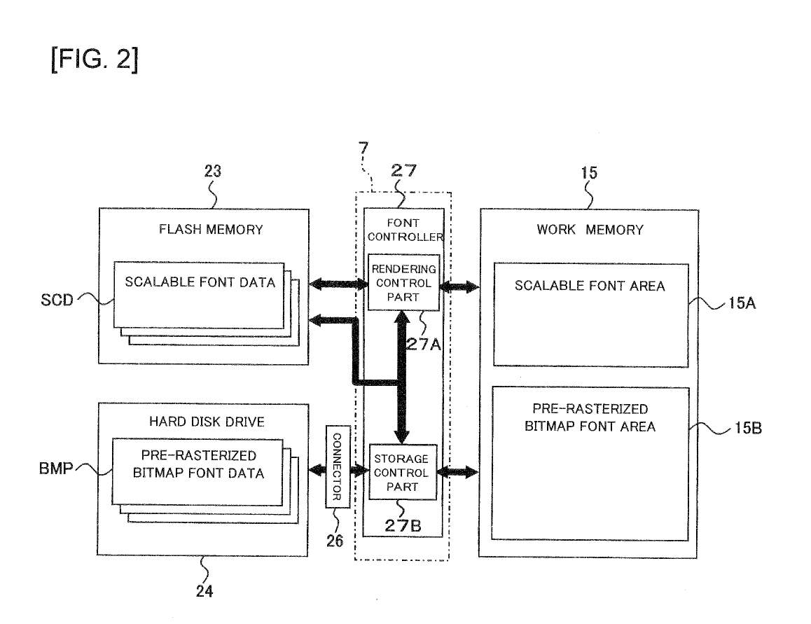

FIG. 2 is a conceptual functional block diagram showing a font control function as a main part of the present invention, which is extracted from the above described functions of the display processing apparatus 25.

In FIG. 2, a font controller 27 is a processing part for performing processes relating to fonts operating on the CPU 7, and is responsible for font-related control of the graphic controller 14 (refer to FIG. 1). The font controller 27 is connected via the bus line 10 (refer to FIG. 1) to the work memory 15, flash memory 23 and the hard disk drive 24 in a readable and writable manner for information.

The flash memory 23 stores a plurality of a scalable font data SCD related to a character or visual object. The scalable font data is a vectorial expression of a locus of a character, and allows display of characters in any size. Although the above described configuration uses a flash memory as a storage medium suitable for storing the scalable font data, the storage medium for the purpose is not limited to this. For example, the scalable font data may be stored in an external storage device such as a hard disk drive or a DVD-ROM drive.

The hard disk drive 24 (to be exact, a hard disk (not shown) contained in the hard disk drive 24. Hereinafter indicated as HDD 24) stores a plurality of pre-rasterized bitmap font data BMP related to a character or visual object. The pre-rasterized bitmap font data is font data in which a scalable font is expanded in advance into a desired size and set as bitmap data. The HDD 24 stores a plurality of pre-rasterized bitmap font data BMP related to desired characters. Incidentally, as stated above, the HDD 24 is installed via the connector 26 in an attachable and detachable manner.

Although the above described arrangement uses a hard disk drive as a storage medium suitable for storing the pre-rasterized bitmap font data, the storage medium for the purpose is not limited to this. For example, the pre-rasterized bitmap font data may be stored in an external storage device such as a flash memory or a DVD-ROM drive.

The work memory 15 is a work memory for storing and holding temporarily scalable font data SCD read from the flash memory 23, and character data and image information on visual objects in a map and the like such as pre-rasterized bitmap font data BMP read from the HDD 24, in a readable and writable manner. The work memory 15 comprises: a scalable font area 15A for making resident the scalable font data SCD (copying data read from the flash memory 23 and the like, and storing temporarily the scalable font data SCD in the work memory 15. This remark also applies to the following description.); and a pre-rasterized bitmap font area 15B for making resident the pre-rasterized bitmap font data BMP read from the HDD 24.

In addition, the work memory 15 may be connected only to the graphic controller 14 as shown in FIG. 1, or may be provided as a predetermined region in a memory connected to the CPU 7 (unified architecture).

The font controller 27 comprises: a storage control part 27B for copying the scalable font data SCD and the pre-rasterized bitmap font data BMPtored in the flash memory 23 and the HDD 24 to the scalable font area 15A and the pre-rasterized bitmap font area 15B of the work memory 15, respectively, and making the same resident therein; and a rendering control part 27A for determining whether or not there exists font data corresponding to a character to be displayed, in the pre-rasterized bitmap font data BMP resident in the pre-rasterized bitmap font area 15B of the work memory 15, and reading the scalable font data SCD from the scalable font area 15A if there exists no font data, or reading the pre-rasterized bitmap font data BMP from the pre-rasterized bitmap font area 15B if there exists the font data, and then carrying out a rendering process.

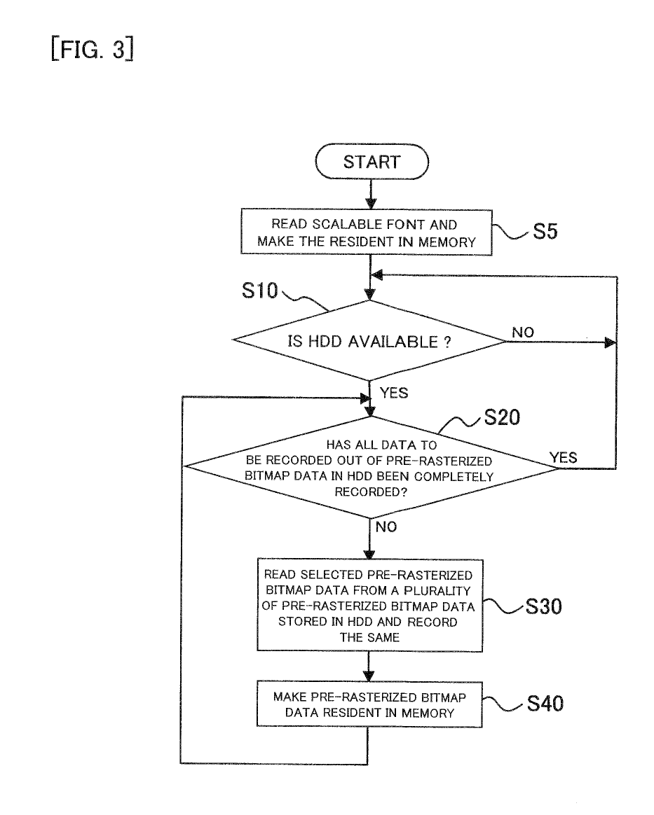

FIG. 3 is a flowchart showing a control process executed by the storage control part 27B. This flowchart is commenced at startup of the vehicle navigation system S.

First, at step S5, scalable font data SCD is read from the flash memory 23, and the read data SCD is copied to the scalable font area 15A of the work memory 15 and made resident therein.

At a next step S10, it is determined whether the HDD 24 is available or not, that is, whether or not the HDD 24 is connected via the connector 26, for instance (this step includes a determination on the usability of the HDD 24 in a broad sense, with consideration given to a situation where the HDD 24 is connected but cannot be used because of a device failure such as a wiring disconnection or a software defect). For example, if the HDD 24 is not connected due to rewriting of data stored in the HDD 24 or replacement of the HDD 24 itself, the step S10 is repeatedly carried out until the HDD 24 is connected and the condition for determination is satisfied. When the condition for determination has been satisfied, the process moves to a next step S20.

In the step S20, it is determined whether or not, out of the pre-rasterized bitmap font data stored in the connected HDD 24, all pre-rasterized bitmap font data to be recorded has been completely recorded in a pre-rasterized bitmap data table (for example, this table may be stored in a memory (not shown) controlled by the font controller 27 or may be stored in an appropriate area of the work memory 15. This remark also applies to the following description). If the recording has been completed, the condition for determination is satisfied, and the process returns to the step S10. If the recording has not been completed, the condition for determination is not satisfied and the process moves to a next step S30.

In the step S30, one pre-rasterized bitmap font data is selected and read from a plurality of pre-rasterized bitmap font data stored in the HDD 24, and is recorded in the pre-rasterized bit map data table.

In next step S40, the pre-rasterized bitmap font data having been completely recorded in the pre-rasterized bitmap data table in the step S30, is made resident in the pre-rasterized bitmap font area 15B of the work memory 15 (the data read from the HDD 24 is copied and temporarily stored in the work memory 15. This remark also applies to the following description). Then, the process returns to the above described step S20.

By the above-described flow, when the HDD 24 is installed, the condition for determination in the step S10 is satisfied, and the steps S20 to S40 are repeated so that, out of the pre-rasterized bitmap font data stored in the connected HDD 24, all pre-rasterized bitmap font data to be recorded is recorded in the pre-rasterized bitmap data table and made resident in the pre-rasterized bitmap font area 15B of the work memory 15. Upon completion of the recording and making resident, the condition for determination in the step S20 is satisfied, and the steps S10 to S20 are repeated to hold the pre-rasterized bitmap font data resident in the work memory 15. At this time, when the HDD 24 becomes unavailable due to removal of the HDD 24 or the like, the condition for determination in the step S10 is not satisfied, and then the step S10 is repeated until the HDD 24 is installed again.

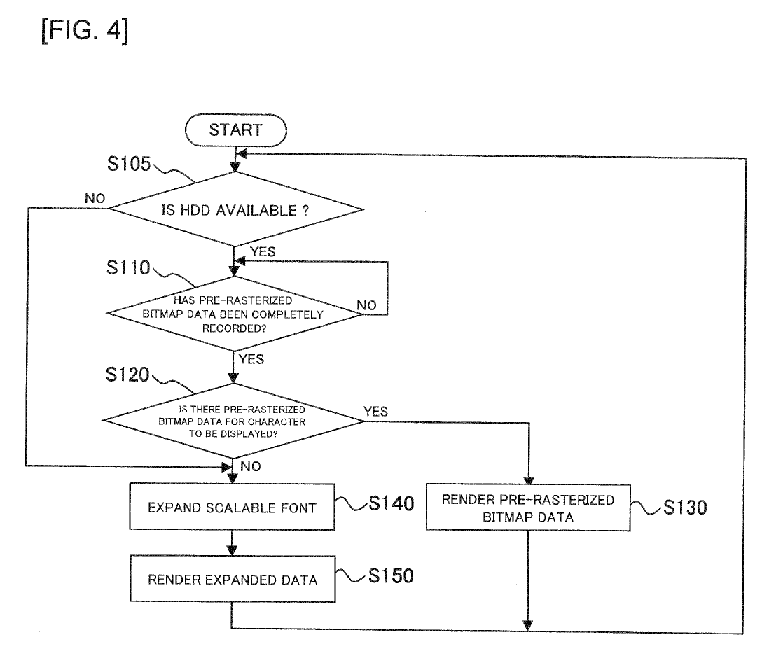

FIG. 4 is a flowchart showing a control process executed by the rendering control part 27A. This flowchart is commenced at startup of the vehicle navigation system S.

First, at step S105, it is determined whether the HDD 24 is available or not, as in the step S10 shown in FIG. 3. For example, if the HDD 24 is not connected due to rewriting of data stored in the HDD 24 or replacement of the HDD 24 itself or the like, the condition for determination is not satisfied and the process moves directly to step S140 described later. On the other hand, if the HDD 24 is connected and available, the condition for determination is satisfied and the process moves to a next step S110.

In the step S110, it is determined whether or not the storage control part 27B has completely recorded all the pre-rasterized bitmap font data to be recorded, out of the pre-rasterized bitmap font data stored in the HDD 24, in the pre-rasterized bitmap data table (for example, this table may be stored in a memory (not shown) controlled by the font controller 27 or may be stored in an appropriate area of the work memory 15. This remark also applies to the following description), that is, whether or not the above described condition for determination in the step S20 shown in FIG. 3 is satisfied or not. This step is repeated until the recording has been completed. Upon completion of the recording, the condition for determination is satisfied and the process moves to a next step S120.

In the step S120, it is determined whether or not there exists pre-rasterized bitmap font data corresponding to a character to be displayed, in the pre-rasterized bitmap data table. If there exists the corresponding pre-rasterized bitmap font data, the condition for determination is satisfied and the process moves to a next step S130.

In the step S130, the pre-rasterized bitmap font data corresponding to the character to be displayed is read from the pre-rasterized bitmap font data resident in the pre-rasterized bitmap font area 15B of the work memory 15, and image information containing the font data is output to the display control part 16 via the graphic controller 14. As a result, the display control part 16 performs display control on the basis of the output image information, and the character to be displayed appears on the display 17. Then, the process returns to the above described step S105.

On the other hand, if it has not been determined at the above described step S120 that there exists the corresponding pre-rasterized bitmap font data, the condition for determination is not satisfied and the process moves to step S140. As described above, if it has been determined at the above described step S105 that the HDD 24 is unavailable, the condition for determination is not satisfied and the process moves directly to a next step S140.

In the step S140, the scalable font data corresponding to the character to be displayed is read from the scalable font data resident in the scalable font area 15A of the work memory 15, and expanded into a size of the character to be displayed.

At a next step S150, image information containing the expanded font data is output to the display control part 16 via the graphic controller 14. As a result, the display control part 16 performs display control on the basis of the output image information, and the character to be displayed appears on the display 17. Then, the process returns to the above described step S105.

By the above described flow, even if the HDD 24 is unavailable due to removal of the HDD 24, for example, the storage control part 27B allows the scalable font data SCD to reside in the scalable font area 15A of the work memory 15 (refer to the step S5 shown in FIG. 3). It is therefore possible to display a character by the use of the resident scalable font data SCD (refer to the steps S105, S140 and S150 shown in FIG. 4).

As described above, the display processing apparatus 25 in the present embodiment is a display processing apparatus 25 for generating and outputting display data for displaying a character or visual object on a display means (display in this example) 17, comprising: a temporary storage means (work memory in this example) 15 for storing and holding the display data in a readable and writable manner; a pre-rasterized data read processing means (the steps S30 and S40 executed by the storage control part 27B in this example) for reading pre-rasterized bitmap data BMP related to a character or visual object, which is stored in a first storage means (hard disk drive in this example), and storing the pre-rasterized bitmap data BMP in the temporary storage means 15; and a scalable data read processing means (the step S5 executed by the storage control part 27B in this example) for reading scalable font data SCD related to a character or visual object, which is stored in a second storage means (flash memory in this example) 23 provided separately from the first storage means 24, and storing the scalable font data SCD in the temporary storage means 15.

While generating display data for displaying a character or visual object, the scalable font data SCD has a property of scaling a character or visual object to any size. The scalable font data SCD, in use, can be expanded in a predetermined region of the temporary storage means 15 to increase a resolution and improve an expressing capability, even with a small amount of data. However, this causes a relatively large load of arithmetic processing for the data expansion. Thus, the pre-rasterized bitmap data BMP expanded to a desired size can be prepared for a frequently-used specific font size or the like, for example, to perform display processing in a relatively short time of arithmetic processing, even though an amount of data to be processed becomes large.

In the present embodiment, the pre-rasterized bitmap data BMP is read from the first storage means 24 by the pre-rasterized data read processing means S30 and S40, and the scalable font data SCD is read from the second storage means 23 by the scalable data read processing means S5, to thereby display the data. That is, the pre-rasterized bitmap data BMP and the scalable font data SCD are stored in the separate storage means 24 and 23. With this arrangement, if either of the storage means may become temporarily disabled due to rewriting of stored data or replacement of the storage means itself, the possibly disabled storage means stores and holds the pre-rasterized bitmap data BMP as the first storage means 24, and the other storage means stores and holds the scalable font data SCD as the second storage means 23. As a result, even when the first storage means 24 is disabled, it is possible to assure a function of displaying a required minimum number of (or a certain number of) a character or visual object by the use of the scalable font data SCD in the second storage means 23.

As described above, the display processing method in the present embodiment is a display processing method for generating and outputting display data for displaying a character or visual object on the display means 17, comprising: a first step S30 and S40 for reading the pre-rasterized bitmap data BMP related to a character or visual object, which is stored and held in the first storage means 24, and storing the pre-rasterized bitmap data BMP in the temporary storage means 15 in a readable and writable manner; and a second step S5 for reading the scalable font data SCD related to a character or visual object, which is stored and held in the second storage means 23 separate from the first storage means 24, and storing the scalable font data SCD in the temporary storage means 15.

In the present embodiment, the pre-rasterized bitmap data BMP is read from the first storage means 24 at the first step S30 and S40, and the scalable font data SCD is read from the second storage means 23 at the second step S5, to thereby display the data. That is, the pre-rasterized bitmap data BMP and the scalable font data SCD are stored in the separate storage means. Accordingly, if either of the storage means may become temporarily disabled due to rewriting of stored data or replacement of the storage means itself, the possibly disabled storage means, as the first storage means 24, stores and holds the pre-rasterized bitmap data BMP, and the other storage means, as the second storage means 23, stores and holds the scalable font data SCD. As a result, even when the first storage means 24 is disabled, it is possible to assure a function of displaying a required minimum number of (or a certain number of) a character or visual object, by the use of the scalable font data SCD in the second storage means 23 that has been made available at the second step S5.

As described above, the display processing program in the present embodiment allows the computation means (CPU in this example) 7 provided in the display processing apparatus 25 to execute: the first step S30 and S40 for reading the pre-rasterized bitmap data BMP related to a character or visual object, which is stored and held in the first storage means 24, and storing the pre-rasterized bitmap data BMP in the temporary storage means 15 in a readable and writable manner; and the second step S5 for reading the scalable font data SCD related to a character or visual object, which is stored in the second storage means 23 separate from the first storage means 24, and storing the scalable font data SCD in the temporary storage means 15.

In the present embodiment, the pre-rasterized bitmap data BMP is read from the first storage means 24 at the first step S30 and S40, and the scalable font data SCD is read from the second storage means 23 at the second step S5, to thereby display the data. That is, the pre-rasterized bitmap data BMP and the scalable font data SCD are stored in the separate storage means 24 and 23. Accordingly, if either of the storage means may become temporarily disabled due to rewriting of stored data or replacement of the storage means itself, the possibly disabled storage means, as the first storage means 24, stores and holds the pre-rasterized bitmap data BMP, and the other storage means, as the second storage means 23, stores and holds the scalable font data SCD. As a result, even when the first storage means 24 is disabled, it is possible to assure a function of displaying a required minimum number of (or a certain number of) a character or visual object, by the use of the scalable font data SCD in the second storage means 23 that has been made available at the second step S5.

In the display processing apparatus 25 of the above described embodiment, the pre-rasterized data read processing means S30 and S40, as the first storage means 24, reads the pre-rasterized bitmap data BMPtored and held in a higher-capacity storage means with a relatively high capacity (hard disk drive in this example) 24, and the scalable data read processing means S5, as the second storage means 23, reads the scalable font data SCD stored and held in a lower-capacity storage means with a relatively low capacity (flash memory in this example) 23.

With this arrangement, even if the higher-capacity storage means 24 storing and holding the pre-rasterized bitmap data BMP becomes temporarily disabled due to replacement or stored data rewriting or the like, it is possible to assure a function of displaying a required minimum number of (or a certain number of) a character or visual object, by the use of the scalable font data SCD in the lower-capacity storage means 23.

The display processing apparatus 25 in the above described embodiment has an attach/detach means (connector in this example) 26 for installing the first storage means 24 in an attachable and detachable manner.

With this arrangement, even if the first storage means 24 to be attached or detached via the attach/detach means 26 is removed for the purpose of rewriting of stored data or replacement of the storage means itself or the like and thus becomes temporarily disabled, it is possible to assure a function of displaying a required minimum number of (or a certain number of) a character or visual object, by the use of the scalable font data SCD in the second storage means 23.

The display processing apparatus 25 in the above described embodiment has a determination means (step S105 executed by the rendering control part 27A in this example) for determining whether the pre-rasterized bitmap data BMP in the first storage means 24 can be read or not. The scalable data read processing means (S140 executed by the rendering control part 27A in this example) reads the scalable font data SCD stored in the temporary storage means 15 if the determination means S105 has not determined that the pre-rasterized bitmap data MBP can be read.

With this arrangement, normally, the pre-rasterized bitmap data BMP read from the first storage means 24 by the pre-rasterized data read processing means S30 and S40 is used, and if the reading becomes disabled, the scalable data read processing means S140 can switch to the scalable font data SCD stored in the temporary storage means 15 to thereby display the data.

The display processing method in the above described embodiment includes: a third step (step S105 executed by the rendering control part 27A in this example) for determining whether the pre-rasterized bitmap data BMP from the first storage means 24 can be read or not; and a fourth step (step S140 executed by the rendering control part 27A in this example) for reading the scalable font data SCD stored in the temporary storage means 15 if it has not been determined at the third step S105 that the pre-rasterized bitmap data BMP can be read.

With this arrangement, normally, the pre-rasterized bitmap data BMP read from the first storage means 24 is used, and if the reading becomes disabled, it is possible to switch to the scalable font data SCD stored in the temporary storage means 15 at the fourth step S140 to thereby display the data.

The display processing apparatus 25 in the above described embodiment has a hard disk (hard disk drive in this example) 24 as the first storage means.

The pre-rasterized data read processing means S30 and S40 reads the pre-rasterized bitmap data BMP from the hard disk 24, and therefore if the hard disk 24 becomes temporarily disabled due to rewriting of stored data in the hard disk 24 or replacement of the hard disk 24 or the like, it is possible to assure a function of displaying a required minimum number of (or a certain number of) a character or visual object, by the use of the scalable font data SCD in the second storage means 23.

In the above described embodiment, one pre-rasterized bitmap font data is selected and read from a plurality of pre-rasterized bitmap font data stored in the HDD 24, recorded in the above-mentioned pre-rasterized bitmap data table, and then made resident in the pre-rasterized bitmap font area 15B of the work memory 15. However, the present invention is not limited to this arrangement. More specifically, instead of reading, recording and making resident each pre-rasterized bitmap font data, it is possible to read and record all pre-rasterized bitmap font data stored in the HDD24 and thereafter make the same collectively resident, for example.

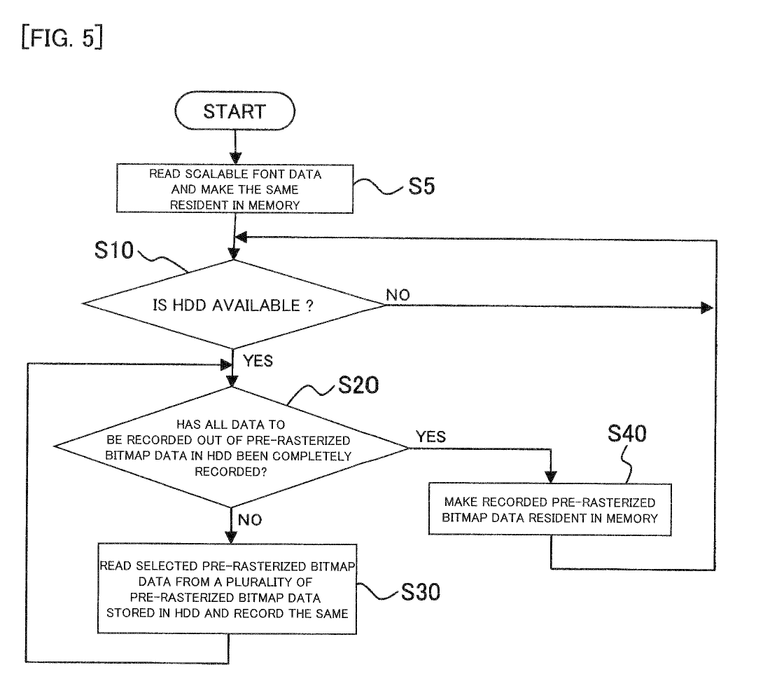

FIG. 5 is a flowchart indicative of a control process executed by the storage control part 27B in this modified embodiment, which corresponds to FIG. 3 described above. This flowchart is commenced at startup of the vehicle navigation system S.

In FIG. 5, steps S5 to S30 are identical to those in FIG. 3, at which the scalable font data SCD read from the flash memory 23 is copied to the scalable font area 15A of the work memory 15 and made resident therein, and it is determined whether the HDD 24 is available or not. If the HDD 24 is available, the condition for determination is satisfied, and then it is determined at the next step S20 whether or not, out of the pre-rasterized bitmap font data stored in the connected HDD 24, all pre-rasterized bitmap font data to be recorded has been completely recorded in the pre-rasterized bitmap data table. If the recording has not been completed, the condition for determination is not satisfied, and at the next step S30, one pre-rasterized bitmap font data is selected and read from the HDD 24 and recorded in the pre-rasterized bitmap data table. On the other hand, if it has been determined in the step S20 that the recording has been completed, the condition for determination is satisfied, and in the step S40, all the pre-rasterized bitmap font data completely recorded in the table is made resident in the pre-rasterized bitmap font area 15B of the work memory 15. Then, the process returns to the above described step S10.

In the above-described modified embodiment, it is possible to obtain the same advantages as those in the above described embodiment.

In addition, the above described embodiment is described in consideration of, as an example, a case where the present invention is applied to a vehicle navigation system for providing guidance on automobile routes. However, the present invention is not limited to the present embodiment, and can be applied to various devices with display processing, such as cellular phones, printers, personal computers (PCs) and personal digital assistances (PDAs) as personal portable terminals, for example.

The display processing apparatus 25 in the above described embodiment is a display processing apparatus 25 for generating and outputting display data for displaying a character or visual object on the display 17, including: the work memory 15 for storing and holding the display data in a readable and writable manner; a storage control part 27B (more specifically, the steps S30 and S40 executed by the storage control part 27B) for reading the pre-rasterized bitmap data BMP related to a character or visual object, which is stored and held in the hard disk drive 24, and storing the pre-rasterized bitmap data BMP in the work memory 15; and a storage control part 27B (more specifically, the step S5 executed by the storage control part 27B) for reading the scalable font data SCD related to a character or visual object, which is stored and held in the flash memory 23 provided separately from the hard disk drive 24, and storing scalable font data SCD in the work memory 15.

In generating display data for displaying a character or visual object, the scalable font data SCD has a property of scaling the character or the visual object to any size. The scalable font data SCD, in use, can be expanded in a predetermined region of the work memory 15 to increase a resolution and improve an expressing capability even with a small amount of data. However, this may cause a relatively large load of arithmetic processing for the data expansion. Thus, the pre-rasterized bitmap data BMP expanded in advance to a desired size can be prepared for a frequently-used specific font size or the like, for example, to perform display processing in a relatively short time of arithmetic processing, even though an amount of data to be processed becomes large.

In the present embodiment, the pre-rasterized bitmap data BMP is read from the hard disk drive 24 by the storage control part 27B (more specifically, the steps S30 and S40 executed by the storage control part 27B), and the scalable font data SCD is read from the flash memory 23 by the storage control part 27B (more specifically, the step S5 executed by the storage control part 27B), to thereby display the data. That is, the pre-rasterized bitmap data BMP and the scalable font data SCD are stored in the separate storage means. With this arrangement, if either of the storage means may become temporarily disabled due to rewriting of stored data or replacement of the storage means itself, the possibly disabled storage means, as the hard disk drive 24, stores and holds the pre-rasterized bitmap data BMP, and the other storage means, as the flash memory 23, stores and holds the scalable font data SCD. As a result, even when the first storage means 24 is disabled, it is possible to assure a function of displaying a required minimum number of (or a certain number of) a character or visual object, by the use of the scalable font data SCD in the flash memory 23.

The display processing method in the above described embodiment is a display processing method for generating and outputting display data for displaying a character or visual object on the display 17, including: a first step S30 and S40 for reading the pre-rasterized bitmap data BMP related to a character or visual object, which is stored and held in the hard disk drive 24, and storing the pre-rasterized bitmap data BMP in the work memory 15 in a readable and writable manner; and a second step S5 for reading the scalable font data SCD related to a character or visual object, which is stored and held in the flash memory 23 separate from the hard disk drive 24, and storing the scalable font data SCD in the work memory 15.

In the present embodiment, the pre-rasterized bitmap data BMP is read from the hard disk drive 24 at the first step S30 and S40, and the scalable font data SCD is read from the flash memory 23 at the second step S5, to thereby display the data. That is, the pre-rasterized bitmap data BMP and the scalable font data SCD are stored in the separate storage means. With this arrangement, if either of the storage means may become temporarily disabled due to rewriting of stored data or replacement of the storage means itself, the possibly disabled storage means, as the hard disk drive 24, stores and holds the pre-rasterized bitmap data BMP, and the other storage means, as the flash memory 23, stores and holds the scalable font data SCD. As a result, even when the hard disk drive 24 is disabled, it is possible to assure a function of displaying a required minimum number of (or a certain number of) a character or visual object, by the use of the scalable font data SCD in the flash memory 23 that has been made available at the second step S5.

1-8. (canceled)

9. A display processing apparatus that generates and outputs display data for displaying a character or visual object on a display unit, comprising:
a temporary storage unit that stores and holds said display data in a readable and writable manner;
a pre-rasterized data read processing unit that reads pre-rasterized bitmap data related to a character or visual object, which is stored and held in a first storage unit, and stores the pre-rasterized bitmap data in said temporary storage unit;
a scalable data read processing unit that reads scalable font data related to a character or visual object, which is stored and held in a second storage unit provided separately from said first storage unit, and stores the scalable font data in said temporary storage unit; and
a determination unit that determines whether said pre-rasterized bitmap data in said first storage unit can be read or not, wherein
said scalable data read processing unit reads said scalable font data stored in said temporary storage unit if said determination unit has not determined that said pre-rasterized bitmap data can be read.

10. The display processing apparatus according to claim 9, wherein
said pre-rasterized data read processing unit, as said first storage unit, reads said pre-rasterized bitmap data stored and held in a higher-capacity storage unit with a relatively high capacity, and
said scalable data read processing unit, as said second storage unit, reads said scalable font data stored and held in a lower-capacity storage unit with a relatively low capacity.

11. The display processing apparatus according to claim 9, further comprising:
an attach/detach unit that installs said first storage unit in an attachable and detachable manner.

12. The display processing apparatus according to claim 9, further comprising:
a hard disk as said first storage unit.

13. A display processing method for generating and outputting display data for displaying a character or visual object on a display unit, comprising:
a first step to read pre-rasterized bitmap data related to a character or visual object, which is stored and held in a first storage unit, and to store the pre-rasterized bitmap data in a temporary storage unit in a readable and writable manner;
a second step to read scalable font data related to a character or visual object, which is stored and held in a second storage unit separate from said first storage unit, and to store the scalable font data in said temporary storage unit;
a third step to determine whether said pre-rasterized bitmap data from said first storage unit can be read or not; and
a fourth step to read said scalable font data stored in said temporary storage unit if it has not been determined at said third step that said pre-rasterized bitmap data can be read.

14. A display processing program for allowing a computation unit provided in a display processing apparatus to execute:
a first step to read pre-rasterized bitmap data related to a character or visual object, which is stored and held in a first storage unit, and to store the pre-rasterized bitmap data in the temporary storage unit in a readable and writable manner;
a second step to read scalable font data related to a character or visual object, which is stored and held in a second storage unit separate from said first storage unit, and to store the scalable font data in said temporary storage unit;
a third step to determine whether said pre-rasterized bitmap data from said first storage unit can be read or not; and
a fourth step to read said scalable font data stored in said temporary storage unit if it has not been determined at said third step that said pre-rasterized bitmap data can be read.
